(19) United States
(12) Patent Application Publication
(10) Pub. No.: US 2009/0223803 A1
(43) Pub. Date: Sep. 10, 2009

(54) Evaporative cooler assisted desalinater

(76) Inventors: Mohinder Singh Bhatti, Williamsville, NY (US); Ilya Reyzin, Williamsville, NY (US); Shrikant Mukund Joshi, Williamsville, NY (US); John Benoit, Lockport, NY (US)

Correspondence Address: DELPHI TECHNOLOGIES, INC., M/C 480-410-202, PO BOX 5052, TROY, MI, 48007, US

(21) Appl. No.: 12/074,672

(22) Filed: Mar. 5, 2008

(51) Int. Cl. C02F 1/04; B01D 5/00

(52) U.S. Cl. 203/10; 202/185.2

(57) ABSTRACT

The invention provides an assembly for desalinating water comprising a cold air duct open to the dry channels of the evaporative cooler and extending around a humidification chamber disposed between the evaporative cooler and the condenser. The invention provides for a film valve including a flexible sheet intersecting the cold air duct for controlling air flow along the cold air duct to the condenser. The film valve allows for a fraction, or all of the cool air in the cold air duct to be utilized for comfort cooling.

### BACKGROUND OF THE INVENTION

1. Field of the Invention

The subject invention relates to desalinating water, and more specifically to desalinating water using the principles of evaporative cooling.

2. Description of the Prior Art

Water desalination refers generally to a process of removing soluble salts from water to render it suitable for drinking, irrigation, or industrial uses. Since much of the Earth's water is salt laden, desalination processes are important in providing fresh water to areas that have insufficient supply. One of the most common methods for desalinating water is known as distillation, where salt water is headed to evaporate the water into vapor, leaving the salt behind. The vapor is then condensed in a separate container. The problem is that the heat for evaporation requires high energy.

U.S. patent application Ser. No. 11,523,416 filed on Sep. 19, 2006 discloses a water desalinater having an evaporative cooler defining a plurality of dry channels and a plurality of wet channels interleaved with and extending transversely to the dry channels. U.S. Pat. No. 6,616,060 discloses a condenser and an air humidification chamber. U.S. Pat. No. 4,267,022 discloses an apparatus for desalinating water, specifically with a means for transferring air from an evaporative cooler to a condenser.

### SUMMARY OF THE INVENTION AND ADVANTAGES

The invention provides an assembly for desalinating water comprising a cold air duct open to the dry channels of the evaporative cooler and extending around a humidification chamber disposed between the evaporative cooler and the condenser. The invention provides for a film valve including a flexible sheet intersecting the cold air duct for controlling air flow along the cold air duct to the condenser. The film valve allows for a fraction, or all of the cool air in the cold air duct to be utilized for comfort cooling.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the present invention,

FIG. 2 is a cross sectional view of the desalinater,

FIG. 3 is a perspective view of the flexible sheet with the openings of the flexible sheet open to the cold air duct,

FIG. 4 is a perspective view of the flexible sheet with the openings of the flexible sheet partially open to the cold air duct and partially to a conditioned space, and

FIG. 5 is a perspective view of the flexible sheet with the openings of the flexible sheet open to the conditioned space.

### DETAILED DESCRIPTION OF THE INVENTION

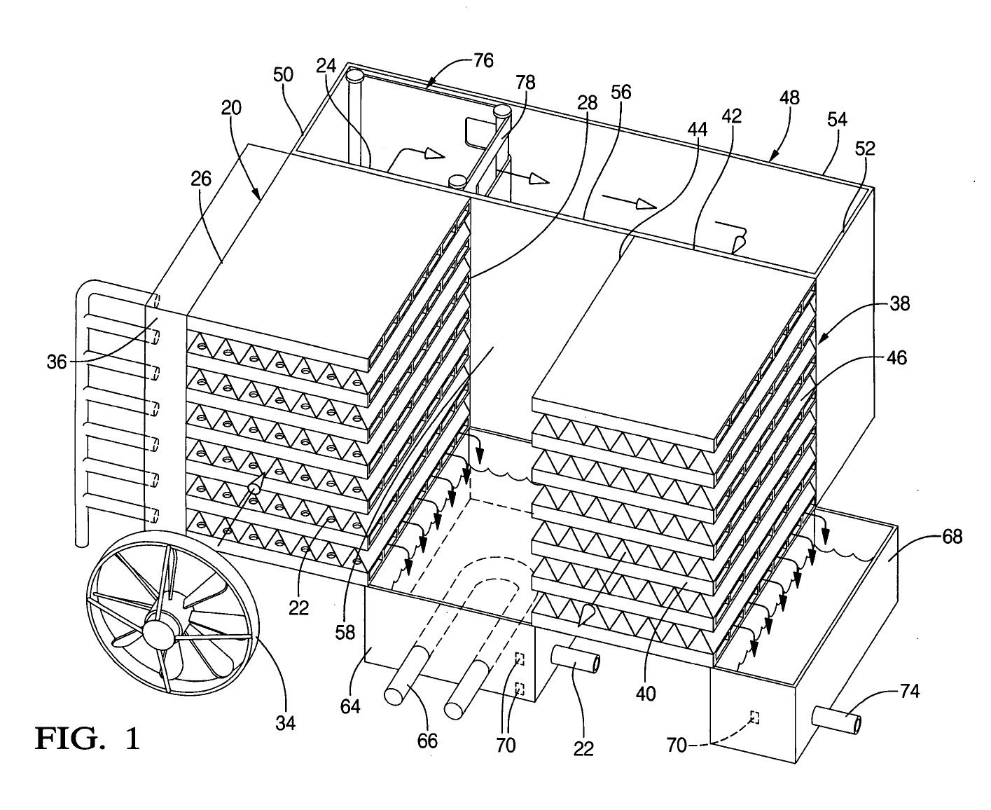

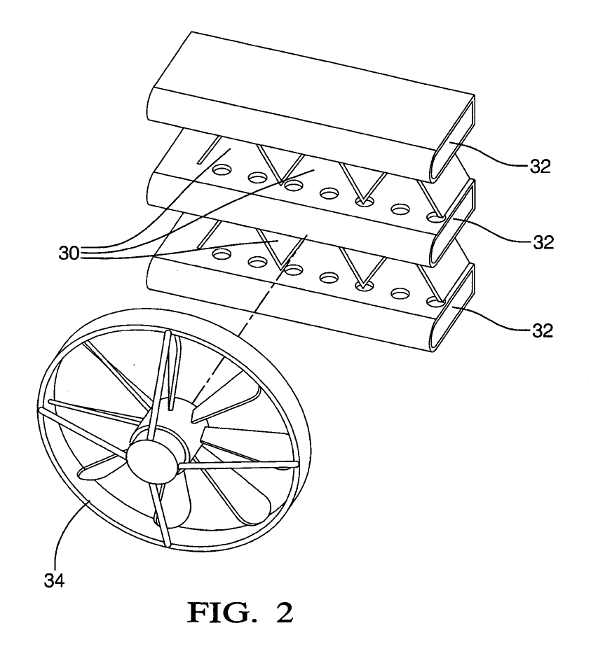

Referring to the Figures, wherein like numerals indicate corresponding parts throughout the several views, an assembly for desalinating water is shown generally in FIGS. 1 and 2. The assembly includes an evaporative cooler 20, generally indicated, having a cooler front 22 and a cooler back 24 and a first cooler side 26 and a second cooler side 28. The evaporative cooler 20 defines a plurality of dry channels 30 extending from the cooler front 22 to the cooler back 24. The evaporative cooler 20 also defines a plurality of wet channels 32 interleaved with and extending transversely to the dry channels 30 and extending from the first cooler side 26 to the second cooler side 28.

A fan 34 is disposed on the cooler front 22 for propelling ambient air into the dry channels 30 and out of the cooler back 24. A sea-water feeding tank 36 is disposed on the first cooler side 26 for flushing the wet channels 32 with the water to produce water vapor exiting the second cooler side 28. A condenser 38, generally indicated, is disposed along side and spaced form the evaporative cooler 20 and includes a condenser front 40 and a condenser back 42 and a first condenser side 44 and a second condenser side 46.

A cold air duct 48, generally indicated, is open to the dry channels 30 at the cooler back 24 and includes a first duct end 50 aligning with the first cooler side 26 and a second duct end 52 aligning with the second condenser side 46 and a duct back 54 extends parallel to and spaced from the cooler backs 24 and interconnecting the duct ends. The cold air duct 48 includes an intermediate panel 56 in alignment with the cooler back 24 and the condenser back 42 and disposed between the second cooler side 28 and the first condenser side 44 for defining an air humidification chamber 58. The air humidification chamber 58 accepts the water vapor from the wet channels 32 of the evaporative cooler 20.

The condenser 38 has a plurality of first passages 60 parallel to and aligned with the wet channels 32 of the cooler 20 for accepting the water vapor from the cooler 20. The condenser 38 also has a plurality of second passages 62 extending from the condenser back 42 to the condenser front 40 and open to the cold air duct 48 for accepting cool air from the cold air duct 48.

An excess water tank 64 is disposed at the bottom of the air humidification chamber 58 for receiving excess water from the evaporative cooler 20. A heating element 66 is disposed in the excess water tank 64 to boil the excess water into vapor for introduction into the air humidification chamber 58 and the condenser 38. A potable water tank 68 is positioned beneath the condenser 38 for receiving condensate of desalinated water from the first passages 60 of the condenser 38. A plurality of level sensors 70 are disposed in the water tanks 64, 68 for sensing the water level. At least one excess drain valve 72 is disposed on the excess water tank 64 for draining excess water from the air humidification chamber 58 in response to the level sensors 70 being activated by rising water levels. At least one potable drain valve 74 is disposed on the potable water tank 68 for draining excess water from the condenser 38 in response to the level sensors 70 being activated by rising water levels.

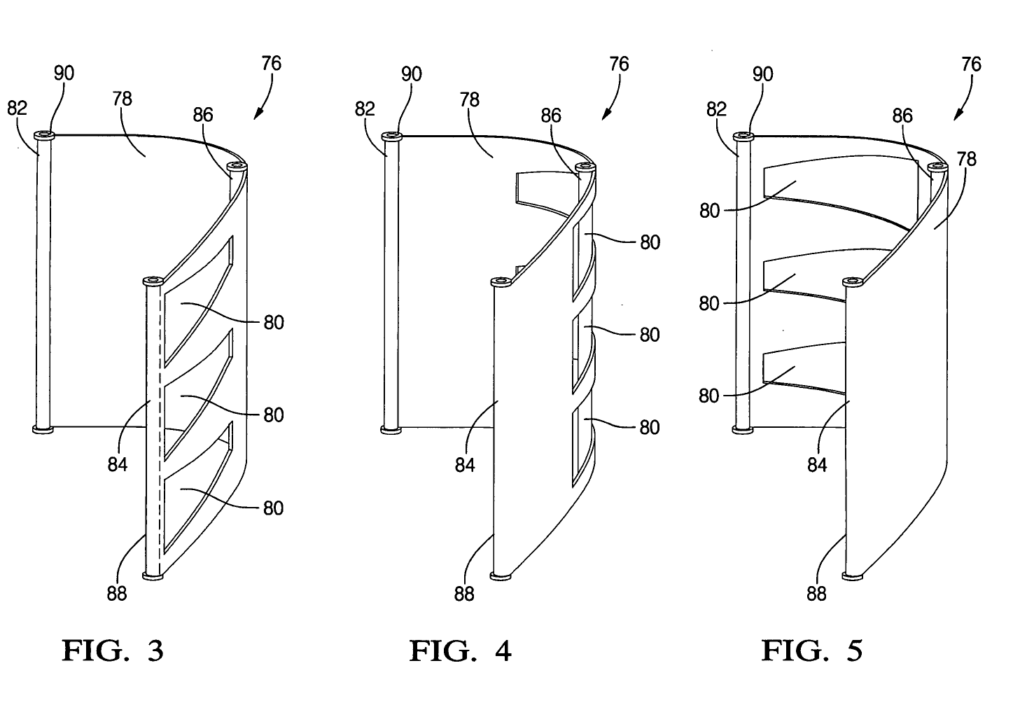

The assembly includes a film valve 76, generally indicated in FIGS. 3, 4, and 5. The film valve 76 includes a flexible sheet 78 extending along the duct back 54 and between the duct back 54 and the intermediate panel 56 in alignment with the second cooler side 28 for controlling air flow along the cold air duct 48. The flexible sheet 78 defines a plurality of openings 80 for controlling the air flow from the cooler 20 through the cold air duct 48 to the condenser 38.

A first winder 82 is disposed at the intersection of the duct back 54 and the first duct end 50 for winding and unwinding one end of the film valve 76. A second winder 84 is disposed at the intersection of the panel 56 at the second cooler side 28 and the cooler back 24 for winding and unwinding the other end of the film valve 76. A valve guide 86 is disposed on the duct back 54 opposite to the second winder 84 for guiding the sheet 78 between the winders 82, 84. A torsion spring 88 biases the second winder 84, keeping tension in the sheet 78. An actuator 90 winds and unwinds the first winder 82, controlling the movement of the sheet 78.

When the openings 80 of the flexible sheet 78 are open to the air duct, all the cool air from the evaporative cooler 20 flows to the condenser 38. When the openings 80 are partially open to the air duct, part of the cool air from the evaporative cooler 20 flows to the condenser 38 and part flows out the duct back 54 to a conditioned space, providing comfort cooling. When the openings 80 are not open to the cold air duct 48 and only open to the duct back 54, all of the cool air from the evaporative cooler 20 flows to the conditioned space, providing comfort cooling.

Accordingly, the invention includes a method of desalinating water. First, warm air is moved through the wet channels 32 into the humidification chamber 58 and through the first passages 60. Cool air is moved through the dry channels 30, running transverse to and interleaved with the wet channels 32. The cool air is ducted separate from and around the air humidification chamber 58 and through the second passages 62, running transverse to and interleaved with the first passages 60.

Sea water is added to the warm air in the wet channels 32 to add humidification to the warm air. The warm air of the humidification chamber 58 is heated prior to entering the first passages 60. The ducting of cool air around the humidification chamber 58 and into the second passages 62 is regulated by intersecting the cool air with a film valve 76 having openings 80 therein. The warm air of the first passages 60 is transferred to the cool air of the second passages 62. The moisture form the warm air in the first passages 60 is condensed. The potable water resulting from the condensing of the moisture is then collected.

Obviously, many modifications and variations of the present invention are possible in light of the above teachings and may be practiced otherwise than as specifically described while within the scope of the appended claims. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. An assembly for desalinating water comprising;
an evaporative cooler defining a plurality of dry channels and a plurality of wet channels interleaved with and extending transversely to said dry channels,
a condenser disposed along side and spaced form said evaporative cooler for defining an air humidification chamber for accepting water vapor from said wet channels of said evaporative cooler,
a cold air duct open to said dry channels and extending around said humidification chamber to said condenser, and
a film valve including a flexible sheet intersecting said cold air duct for controlling air flow along said cold air duct.

2. An assembly as set forth in claim 1 wherein said flexible sheet defines a plurality of openings for controlling the air flow from said cooler through said cold air duct to said condenser.

3. An assembly as set forth in claim 2 wherein said condenser has a condenser front and a condenser back and a first condenser side and a second condenser side.

4. An assembly as set forth in claim 3 wherein said condenser defines a plurality of first passages axially aligned with said wet channels of said cooler for accepting the water vapor from said humidification chamber and a plurality of second passages extending from said condenser back to said condenser front and open to said cold air duct for receiving cool air from said cold air duct.

5. An assembly as set forth in claim 4 including a potable water tank positioned beneath said condenser for receiving condensate of desalinated water from said first passages of said condenser.

6. An assembly as set forth in claim 5 including at least one level sensor disposed in said potable water tank for sensing the water level.

7. An assembly as set forth in claim 6 including at least one potable drain valve disposed on said potable water tank for draining excess water from said condenser in response to the level sensors being activated by rising water levels.

8. An assembly as set forth in claim 3 wherein said evaporative cooler has a cooler front and a cooler back and a first cooler side and a second cooler side.

9. An assembly as set forth in claim 8 wherein said cold air duct includes an intermediate panel aligned with said cooler back and said condenser back and disposed between said second cooler side and said first condenser side.

10. An assembly as set forth in claim 9 wherein said cold air duct is open to said dry channels at said cooler back and includes a first duct end aligning with said first cooler side and a second duct end aligning with said second condenser side and a duct back extending parallel to and spaced from said cooler backs and interconnecting said duct ends.

11. An assembly as set forth in claim 10 wherein said flexible sheet extends along said duct back and between said duct back and said intermediate panel in alignment with said second cooler side for controlling air flow along said cold air duct,

12. An assembly as set forth in claim 11 wherein said film valve includes a first winder disposed at the intersection of said duct back and said first duct end for winding and unwinding one end of said flexible sheet and a second winder disposed at the intersection of said panel at said second cooler side and said cooler back for winding and unwinding the other end of said flexible sheet.

13. An assembly as set forth in claim 12 wherein said film valve a valve guide disposed on said duct back opposite to said second winder for guiding said sheet between said winders.

14. An assembly as set forth in claim 13 wherein said film valve includes a torsion spring biasing said second winder for keeping tension in said sheet.

15. An assembly as set forth in claim 14 wherein said film valve includes an actuator for winding and unwinding said first winder for controlling the movement of said sheet.

16. An assembly as set forth in claim 9 including an excess water tank disposed at the bottom of said air humidification chamber for receiving excess water from said evaporative cooler.

17. An assembly as set forth in claim 16 including a heating element disposed in said excess water tank to boil the excess water into vapor for introduction into said air humidification chamber and said condenser.

18. An assembly as set forth in claim 16 including a least one level sensor disposed in said excess water tank for sensing the water level.

19. An assembly as set forth in claim 18 including at least one excess drain valve disposed on said excess water tank for draining excess water from said air humidification chamber in response to the level sensors being activated by rising water levels.

20. An assembly as set forth in claim 8 including a fan disposed on said cooler front for propelling ambient air into said dry channels and out of said cooler back,

21. An assembly as set forth in claim 8 including a sea-water feeding tank disposed on said first cooler side for flushing said wet channels with said water to produce water vapor exiting said second cooler side.

22. An assembly for desalinating water comprising;
an evaporative cooler having a cooler front and a cooler back and a first cooler side and a second cooler side,
said evaporative cooler defining a plurality of dry channels extending from said cooler front to said cooler back,
said cooler defining a plurality of wet channels interleaved with and extending transversely to said dry channels and extending from said first cooler side to said second cooler side,
a fan disposed on said cooler front for propelling ambient air into said dry channels and out of said cooler back,
a sea-water feeding tank disposed on said first cooler side for flushing said wet channels with said water to produce water vapor exiting said second cooler side,
a condenser disposed along side and spaced form said evaporative cooler and including a condenser front and a condenser back and a first condenser side and a second condenser side,
a cold air duct open to said dry channels at said cooler back and including a first duct end aligning with said first cooler side and a second duct end aligning with said second condenser side and a duct back extending parallel to and spaced from said cooler backs and interconnecting said duct ends,
said cold air duct including an intermediate panel aligned with said cooler back and said condenser back and disposed between said second cooler side and said first condenser side for defining an air humidification chamber for accepting said water vapor from said wet channels of said evaporative cooler,
said condenser having a plurality of first passages parallel to and aligned with said wet channels of said cooler for accepting the water vapor from said cooler and a plurality of second passages extending from said condenser back to said condenser front and open to said cold air duct for accepting cool air from said cold air duct,
an excess water tank disposed at the bottom of said air humidification chamber for receiving excess water from said evaporative cooler,
a heating element disposed in said excess water tank to boil said excess water into vapor for introduction into said air humidification chamber and said condenser,
a potable water tank positioned beneath said condenser for receiving condensate of desalinated water from said first passages of said condenser,
a plurality of level sensors disposed in said water tanks for sensing the water level,
at least one excess drain valve disposed on said excess water tank for draining excess water from said air humidification chamber in response to the level sensors being activated by rising water levels
at least one potable drain valve disposed on said potable water tank for draining excess water from said condenser in response to the level sensors being activated by rising water levels.
a film valve including a flexible sheet extending along said duct back and between said duct back and said intermediate panel in alignment with said second cooler side for controlling air flow along said cold air duct,
said flexible sheet defining a plurality of openings for controlling the air flow from said cooler through said cold air duct to said condenser,
a first winder disposed at the intersection of said duct back and said first duct end for winding and unwinding one end of said film valve,
a second winder disposed at the intersection of said panel at said second cooler side and said cooler back for winding and unwinding the other end of said film valve,
a valve guide disposed on said duct back opposite to said second winder for guiding said sheet between said winders,
a torsion spring biasing said second winder for keeping tension in said sheet, and
an actuator for winding and unwinding said first winder for controlling the movement of said sheet.

23. A method for of desalinating water comprising;
moving warm air through wet channels into a humidification chamber and through a plurality of first passages,
moving cool air through dry channels running transverse to and interleaved with the wet channels and ducting the cool air separate from and around the air humidification chamber and through a plurality of second passages running transverse to and interleaved with the first passages,
adding sea water to the warm air in the wet channels to add humidification to the warm air,
heating the warm air with humidity in the humidification chamber prior to entering the first passages
regulating the ducting of cool air around the humidification chamber and into the second passages by intersecting the cool air with a film valve having openings therein,
transferring there from the warm air of the first passages to the cool air of the second passages,
condensing the moisture from the warm air in the first passages,
collecting potable water resulting from the condensing of the moisture,
